(19) United States
(12) Patent Application Publication
(10) Pub. No.: US 2024/0246527 A1
(43) Pub. Date: Jul. 25, 2024

(54) VEHICLE CONTROL APPARATUS

(71) Applicant: SUBARU CORPORATION, Tokyo (JP)

(72) Inventor: Koji MATSUNO, Tokyo (JP)

(21) Appl. No.: 18/408,406

(22) Filed: Jan. 9, 2024

(30) Foreign Application Priority Data
Jan. 23, 2023 (JP) 2023-007772

(51) Int. Cl. B60W 10/18; B60W 10/16

(52) U.S. Cl. CPC B60W 10/18; B60W 10/16; B60W 2520/14; B60W 2710/12; B60W 2710/18

(57) ABSTRACT

A vehicle control apparatus is applied to a vehicle including a turning inner wheel, a turning outer wheel, and a limited slip differential. The vehicle control apparatus includes a target yaw moment setter, a target braking force setter, and a braking device. The target yaw moment setter sets a target yaw moment of the vehicle. The target braking force setter sets a target braking force to be added to the turning inner wheel based on the target yaw moment. The braking device adds a braking force to the turning inner wheel based on the target braking force. The target braking force setter incrementally corrects the target braking force based on a transmission torque transmitted from the turning inner wheel to the turning outer wheel by the limited slip differential.

### CROSS-REFERENCE TO RELATED APPLICATIONS

The present application claims priority from Japanese Patent Application No. 2023-007772 filed on Jan. 23, 2023, the entire contents of which are hereby incorporated by reference.

### BACKGROUND

The disclosure relates to a vehicle control apparatus that generates a yaw moment by causing a turning inner wheel of a vehicle to generate a braking force.

As a technique related to behavior control of a vehicle such as an automobile, for example, Japanese Unexamined Patent Application Publication (JP-A) No. 2013-193553 discloses a vehicle control device configured to: calculate a target yaw moment to be added to a vehicle and a driving force of the vehicle; correct the driving force based on a steering wheel angle, a distance from the own vehicle to an obstacle, and differential rotation between right and left wheels; variably set, based on a corrected value, a proportion of driving force control to be added to a turning outer wheel and a proportion of braking force control to be added to a turning inner wheel to generate the target yaw moment; and output the proportion of driving force control and the proportion of braking force control to a clutch drive unit and a brake drive unit to cause each of the clutch drive unit and the brake drive unit to execute the corresponding control.

JP-A No. 2014-43213 discloses a four-wheel-drive vehicle control device configured to: calculate a target braking-driving force corresponding to a target yaw moment adapted to an understeer tendency of a vehicle; calculate a target driving force for a turning outer wheel of a rear shaft freely added to the vehicle by driving force distribution control by a transfer clutch and right and left wheel clutches; and calculate, as a target braking force for a turning inner wheel, a shortage of the target driving force for the turning outer wheel of the rear shaft by comparing the target braking-driving force with the target driving force for the turning outer wheel of the rear shaft. The target driving force for the turning outer wheel of the rear shaft engages a wheel clutch on a side of the turning outer wheel of the rear shaft and disengages a wheel clutch on a side of the turning inner wheel to control and generate an engagement force of the transfer clutch. The target braking force for the turning inner wheel is distributed back and forth and added based on a driver's intention to accelerate.

JP-A No. 2017-136908 discloses a control device for a vehicle in which driving force distribution between right and left wheels is to be changed. In the control device for the vehicle, when a magnitude of a requested yaw moment is greater than or equal to a predetermined limit value, driving force distribution to right and left rear wheels is controlled in such a manner that a post-limit yaw moment corresponding to the limit value is obtained, in order to reduce the shortage of the yaw moment even when traveling on an irregular road, and the braking force is added to a front wheel on a turning inner side in such a manner that the yaw moment increases based on a difference value obtained by subtracting the post-limit yaw moment from the requested yaw moment.

JP-A No. 2000-272489 discloses a vehicle body behavior control device configured to: estimate a behavior condition of a vehicle based on a difference in respective wheel speeds of right and left wheels of the vehicle and a lateral momentum; set a wheel braking force application amount for a wheel braking force generating unit based on the behavior condition; and adjust a wheel braking force based on the wheel braking force application amount.

### SUMMARY

An aspect of the disclosure provides a vehicle control apparatus to be applied to a vehicle. The vehicle includes a turning inner wheel, a turning outer wheel, and a limited slip differential. The limited slip differential is configured to transmit a torque between the turning inner wheel and the turning outer wheel, and limit differential rotation between the turning inner wheel and the turning outer wheel. The vehicle control apparatus includes a target yaw moment, a target braking force setter, and a braking device. The target yaw moment setter is configured to set a target yaw moment of the vehicle. The target braking force setter is configured to set a target braking force to be added to the turning inner wheel based on the target yaw moment. The braking device is configured to add a braking force to the turning inner wheel based on the target braking force. The target braking force setter is configured to incrementally correct the target braking force based on a transmission torque transmitted from the turning inner wheel to the turning outer wheel by the limited slip differential.

An aspect of the disclosure provides a vehicle control apparatus to be applied to a vehicle. The vehicle includes a turning inner wheel, a turning outer wheel, and a limited slip differential. The limited slip differential is configured to transmit a torque between the turning inner wheel and the turning outer wheel, and limit differential rotation between the turning inner wheel and the turning outer wheel. The vehicle control apparatus includes circuitry and a braking device. The circuitry is configured to: set a target yaw moment of the vehicle; set a target braking force to be added to the turning inner wheel based on the target yaw moment; and incrementally correct the target braking force based on a transmission torque transmitted from the turning inner wheel to the turning outer wheel by the limited slip differential. The braking device is configured to add a braking force to the turning inner wheel based on the target braking force.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram schematically illustrating a configuration of a vehicle including a vehicle control apparatus according to one example embodiment of the disclosure.

FIG. 2 is a diagram schematically illustrating torque transmission states between a left front wheel and a right front wheel before and after a brake control override of a turning inner wheel.

FIG. 3 is a diagram illustrating an example of transition of a braking-driving force and an LSD transfer torque of the turning inner and outer wheels when a braking force is applied to the turning inner wheel.

FIG. 4 is a diagram illustrating an example of transition of a yaw rate and a brake fluid pressure of the turning inner wheel when the braking force is applied to the turning inner wheel.

FIG. 5 is a flowchart illustrating an operation of the vehicle control apparatus according to one example embodiment.

FIG. 6 is a diagram illustrating an example of transition of wheel speeds of respective wheels when braking is performed on a front wheel on a turning inner side.

FIG. 7 is a diagram illustrating an example of a control waveform when an accelerator is turned on during turning in the vehicle control apparatus according to one example embodiment.

FIG. 8 is a diagram illustrating an example of a control waveform when an accelerator is turned on during turning in the vehicle control apparatus according to one example embodiment.

FIG. 9 is a diagram illustrating an example of a control waveform when an accelerator is turned on during turning in the vehicle control apparatus according to one example embodiment.

FIG. 10 is a diagram illustrating an example of a control waveform when an accelerator is turned on during turning in the vehicle control apparatus according to one example embodiment.

FIG. 11 is a diagram illustrating an example of a control waveform when an accelerator is turned on during turning in the vehicle control apparatus according to one example embodiment.

### DETAILED DESCRIPTION

In a vehicle in which a limited slip differential (LSD) mechanism is incorporated between right and left wheels, a driving torque is transferred from a turning inner wheel to a turning outer wheel during turning acceleration, and a driving force of the turning outer wheel is increased, thereby generating a yaw moment in a direction (an oversteer direction) that promotes the turning.

However, if a braking force is applied to the turning inner wheel in order to further increase the yaw moment from this state, an operation of the limited slip differential mechanism and inner wheel braking control may interfere with each other, which can result in that a sufficient increase in yaw moment is unobtainable.

It is desirable to provide a vehicle control apparatus that makes it possible to effectively increase a yaw moment by inner wheel braking even if the vehicle control apparatus has a limited slip differential mechanism.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Example Embodiment

A vehicle control apparatus according to a first example embodiment of the disclosure will be described below. The vehicle control apparatus according to the first example embodiment may be provided in an automobile such as a passenger car, and may cause a vehicle body to generate a yaw moment with use of a braking-driving force difference between right and left wheels (a turning inner wheel and a turning outer wheel) during turning.

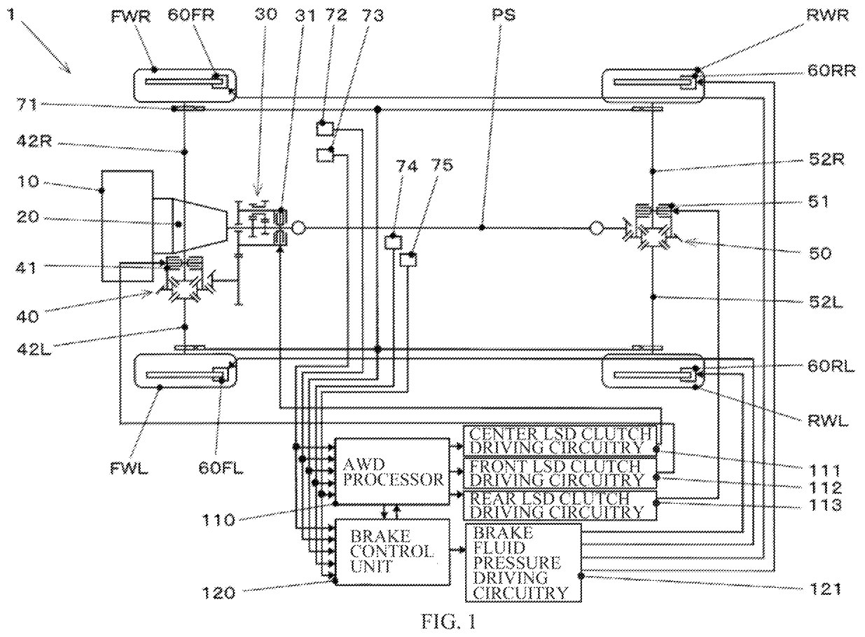

FIG. 1 is a diagram schematically illustrating a configuration of a vehicle including the vehicle control apparatus according to the first example embodiment.

A vehicle 1 may be a four-wheeled vehicle including a right front wheel FWR, a left front wheel FWL, a right rear wheel RWR, and a left rear wheel RWL.

The vehicle 1 may include, for example, an engine 10, a transmission 20, a center differential 30, a front differential 40, a rear differential 50, multiple brakes 60 (60FR, 60FL, 60RR, and 60RL), multiple vehicle speed sensors 71, an accelerator pedal sensor 72, a steering angle sensor 73, an acceleration sensor 74, a yaw rate sensor 75, an all-wheel drive (AWD) processor 110, and a brake control unit 120. In one embodiment, the brake control unit 120 may serve as a “brake processor”.

The engine 10 may be, for example, an internal combustion engine such as a gasoline engine that serves as a driving power source for the vehicle 1.

The transmission 20 may be a power transmission device that transmits the power of the engine 10 to the center differential 30.

The transmission 20 may include, for example, a transmission mechanism such as a chain continuously variable transmission (CVT), a starting device such as a torque converter, and a forward/reverse switching mechanism.

The center differential 30 may transmit the power of the engine 10 transmitted from the transmission 20 to each of the front differential 40 and the rear differential 50.

The center differential 30 may include a differential mechanism that allows for differential rotation (a revolution speed difference) between the front differential 40 and the rear differential 50.

The center differential 30 may include a center LSD 31.

The center LSD 31 may include a wet multi-plate clutch (a frictional engagement element) of, for example, an electromagnetic type or a hydraulic type. The wet multi-plate clutch may lock differential rotation between an output unit, of the center differential 30, on a side of the front differential 40 and an output unit, of the center differential 30, on a side of the rear differential 50.

A locking force of the center LSD 31 may be controlled by a center LSD clutch driving circuitry 111 to be described later.

The front differential 40 may be an axle differential provided on a front shaft that is a first drive shaft of the vehicle 1.

The front differential 40 may transmit a driving force to be transmitted from the center differential 30 to each of the right front wheel FWR and the left front wheel FWL.

The front differential 40 may include a differential mechanism that allows for differential rotation between the right front wheel FWR and the left front wheel FWL.

The front differential 40 may include a front LSD 41.

The front LSD 41 may include a wet multi-plate clutch (a frictional engagement element) of, for example, an electromagnetic type or a hydraulic type. The wet multi-plate clutch may lock differential rotation between an output unit, of the front differential 40, on a side of the right front wheel FWR and an output unit, of the front differential 40, on a side of the left front wheel FWL.

A locking force (a transmission torque) of the front LSD 41 may be controlled by a front LSD clutch driving circuitry 112 to be described later.

The front LSD 41 may be an electronically controlled LSD configured to change the locking force in response to a command from the AWD processor 110.

A right drive shaft 42R that is a power transmission shaft may be provided between the front differential 40 and the right front wheel FWR. A left drive shaft 42L that is a power transmission shaft may be provided between the front differential 40 and the left front wheel FWL.

The rear differential 50 may be an axle differential provided on a rear shaft that is a second drive shaft of the vehicle 1.

The center differential 30 may transmit the driving force to the rear differential 50 via a propeller shaft PS.

The rear differential 50 may transmit the driving force to be transmitted from the center differential 30 to each of the right rear wheel RWR and the left rear wheel RWL.

The rear differential 50 may include a differential mechanism that allows for differential rotation between the right rear wheel RWR and the left rear wheel RWL.

The rear differential 50 may include a rear LSD 51.

The rear LSD 51 may include a wet multi-plate clutch (a frictional engagement element) of, for example, an electromagnetic type or a hydraulic type. The wet multi-plate clutch may lock differential rotation between an output unit, of the rear differential 50, on a side of the right rear wheel RWR and an output unit, of the rear differential 50, on a side of the left rear wheel RWL.

In one example embodiment, the front LSD 41 and the rear LSD 51 may each serve as a “limited slip differential”.

A locking force (a transmission torque) of the rear LSD 51 may be controlled by a rear LSD clutch driving circuitry 113.

The rear LSD 51 may be an electronically controlled LSD configured to change the locking force in response to the command from the AWD processor 110.

A right drive shaft 52R that is a power transmission shaft may be provided between the rear differential 50 and the right rear wheel RWR. A left drive shaft 52L that is a power transmission shaft may be provided between the rear differential 50 and the left rear wheel RWL.

The multiple brakes 60 may be provided in the respective wheels. In one example embodiment, the brake 60 may serve as a “braking device”. The brake 60 generates a braking force.

FIG. 1 illustrates brakes 60FR, 60FL, 60RR, and 60RL respectively provided in the right front wheel FWR, the left front wheel FWL, the right rear wheel RWR, and the left rear wheel RWL.

Each brake 60 may be, for example, a hydraulic service brake and may generate a braking force based on a brake fluid pressure to be provided from a brake fluid pressure driving circuitry 121 to be described below.

The vehicle speed sensors 71 may each be provided in a hub bearing housing that rotatably supports corresponding one of the wheels, and may each output a vehicle speed signal corresponding to a revolution speed of corresponding one of the wheels.

Wheel speeds (wheel revolution speeds) of the respective wheels may be calculated based on the vehicle speed signals outputted from the respective vehicle speed sensors 71.

The revolution speed difference between the turning inner wheel and the turning outer wheel may be calculated based on an output of the vehicle speed sensor 71 provided in the turning inner wheel and an output of the vehicle speed sensor 71 provided in the turning outer wheel.

In one example embodiment, the vehicle speed sensors 71 may each serve as a “revolution speed difference detector”.

The accelerator pedal sensor 72 may detect an operation amount (a stroke) of an accelerator pedal on which a driver performs an accelerator operation.

An engine control unit that comprehensively control the engine 10 and accessories thereof may set a driver requested torque based on, for example, an output of the accelerator pedal sensor 72, and control the power of the engine 10 in such a manner that a torque to be actually generated by the engine 10 matches the driver required torque.

The steering angle sensor 73 may detect a steering angle of the front wheels (the right front wheel FWR and the left front wheel FWL) that are steering control wheels.

The steering angle sensor 73 may include, for example, an encoder configured to detect a rotational angular position of a steering shaft coupled to the steering wheel.

The acceleration sensor 74 may detect acceleration in a front-rear direction and acceleration in a lateral direction that are acting on the vehicle body.

The yaw rate sensor 75 may detect a yaw rate that is a rotation angular velocity around a vertical axis of the vehicle body.

The AWD processor 110 may be a control device that supplies a command to each of the center LSD clutch driving circuitry 111, the front LSD clutch driving circuitry 112, and the rear LSD clutch driving circuitry 113 based on a traveling state of the vehicle, and controls the locking force (a clutch engagement force) of each of the center LSD 31, the front LSD 41, and the rear LSD 51).

The center LSD clutch driving circuitry 111, the front LSD clutch driving circuitry 112, and the rear LSD clutch driving circuitry 113 may each be a driving device that supply a driving force to the clutch of corresponding one of the center LSD 31, the front LSD 41, and the rear LSD 51, and may each change the locking force of corresponding one of the LSDs, in response to the command from the AWD processor 110.

In one example embodiment, the AWD processor 110 may serve as a “limited slip differential processor”.

The AWD processor 110 may be configured, during turning acceleration of the vehicle 1, to cause the front LSD 41 and the rear LSD 51 to be in a locked state (an engaged state) based on an increase in slipping of the turning inner wheel corresponding to an increase in the driving force of the turning inner wheel, and to further cause the transmission torque (a transfer torque) to increase.

With such control, the transfer torque may be transferred from the turning inner wheel to the turning outer wheel, and the driving force of the turning outer wheel may be increased, thereby generating the yaw moment in the oversteer direction.

In contrast, when the LSDs are engaged with each other in a state where the turning inner wheel has a margin in the gripping force, the locking of the differential rotation between the turning inner wheel and the turning outer wheel may generate the yaw moment in an understeer direction corresponding to a difference in passing trajectories of the respective wheels.

The brake control unit 120 may be a control device that supplies a command to the brake fluid pressure driving circuitry 121 based on a braking operation performed by the driver and the traveling state of the vehicle, and controls the braking force of the brake 60 of each wheel.

The brake fluid pressure driving circuitry 121 may be a driving device that, in response to the command from the brake control unit 120, individually generates the brake fluid pressure to be provided to the brake 60 of each wheel, and generates the braking force for each brake 60.

In one example embodiment, the brake control unit 120 may serve as a “target yaw moment setter” and a “target braking force setter”.

In one example embodiment, the brake control unit 120 may also serve as a “target yaw rate setter” that sets a target yaw rate of the vehicle, and a “yaw rate estimator” that estimates a yaw rate γw based on a revolution speed difference between the turning inner wheel and the turning outer wheel detected by the vehicle speed sensor 71.

The AWD processor 110 and the brake control unit 120 may each be configured as a computer including, for example, an information processor such as a CPU, a storage such as a RAM or a ROM, an input/output interface, and a bus that couples these components.

The AWD processor 110 and the brake control unit 120 may be communicably coupled to each other via an in-vehicle LAN such as a CAN communication system.

The outputs of the respective sensors 71 to 75 are transmitted to each of the AWD processor 110 and the brake control unit 120.

Hereinafter, control to be performed in the vehicle control apparatus according to the first example embodiment will be described.

In general, if known vehicle behavior control in which the braking force is applied to the turning inner wheel during turning to generate the yaw moment in the oversteer direction is applied to a vehicle, and if the vehicle includes the LSD in the drive shaft as with the first example embodiment, the yaw moment in the oversteer direction can, on the contrary, be reduced.

In the following explanation, phenomena occurring in the right and left front wheels and the front differential will be described in order to facilitate understanding. However, phenomena similar to those occurring in the right and left front wheels may occur in the rear wheels.

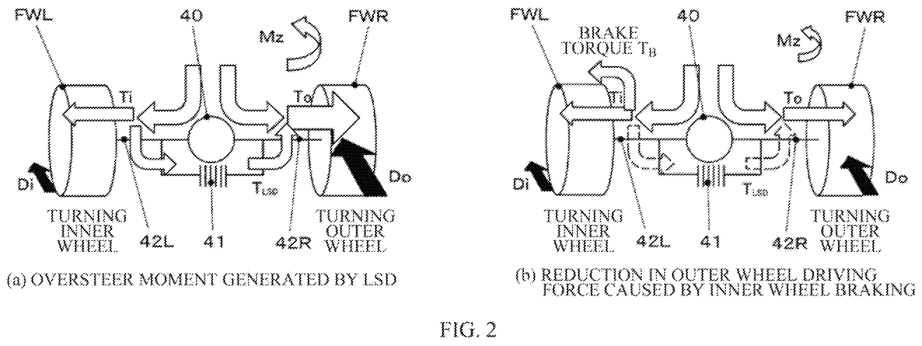

FIG. 2 is a diagram schematically illustrating torque transmission states between the left front wheel and the right front wheel before and after a brake control override of the turning inner wheel.

In FIG. 2, a size of an arrow indicates a magnitude of the torque or a magnitude of the braking-driving force.

In FIG. 2, (a) illustrates the state before the start of the inner wheel braking, and (b) illustrates the state after the start of inner wheel braking.

When the vehicle 1 is turned while being accelerated in a state of the accelerator being turned on, the turning inner wheel in which a vertical load is reduced due to load shift may become excessive in the driving force and start slipping, as illustrated in (a) of FIG. 2. The start of slipping may cause the driving torque to be transferred from the turning inner wheel to the turning outer wheel via the front LSD 41.

This may cause a driving force Do of the turning outer wheel to relatively increase with respect to a driving force Di of the turning inner wheel, and cause the front LSD 41 to generate the yaw moment in the oversteer direction.

When the brake 60 of the turning inner wheel is caused to generate the braking force in order to further increase the yaw moment in the oversteer direction from the state illustrated in (a) of FIG. 2, the brake 60 of the turning inner wheel may absorb the torque that has been flowing to the turning outer wheel by the LSD as illustrated in (b) of FIG. 2. This may accordingly reduce the driving force of the turning outer wheel that is not a braking wheel.

Thus, generating the braking force in the turning inner wheel can, on the contrary, reduce the yaw moment in the oversteer direction.

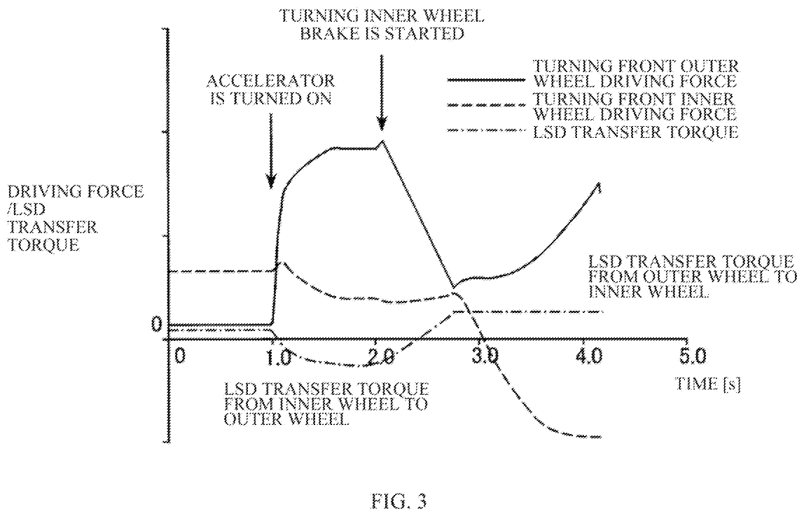

FIG. 3 is a diagram illustrating an example of transition of the braking-driving force and an LSD transfer torque of the turning inner and outer wheels when the braking force is applied to the turning inner wheel.

In FIG. 3, the horizontal axis represents time, and the vertical axis represents the braking-driving force (the top represents a side of driving and the bottom represents a side of braking) and the transfer torque (the top represents the direction from the turning outer wheel to the turning inner wheel) of the LSD.

In FIG. 3, for example, the accelerator may be turned on from the time point of 1 second.

In response to turning on of the accelerator, the torque may be transferred from the turning inner wheel to the turning outer wheel, and the driving force of the turning outer wheel increases.

This may generate the yaw moment in the oversteer direction.

Thereafter, the application of the braking force to the turning inner wheel may be started from around 2 seconds. At this time, the LSD transfer torque may be absorbed by the brake torque of the turning inner wheel, and the direction of the torque transfer may be switched into a direction from the turning outer wheel to the turning inner wheel.

Thus, although the turning inner wheel is braked, the driving force of the turning outer wheel may reduce, which can, on the contrary, reduce the yaw moment in the oversteer direction.

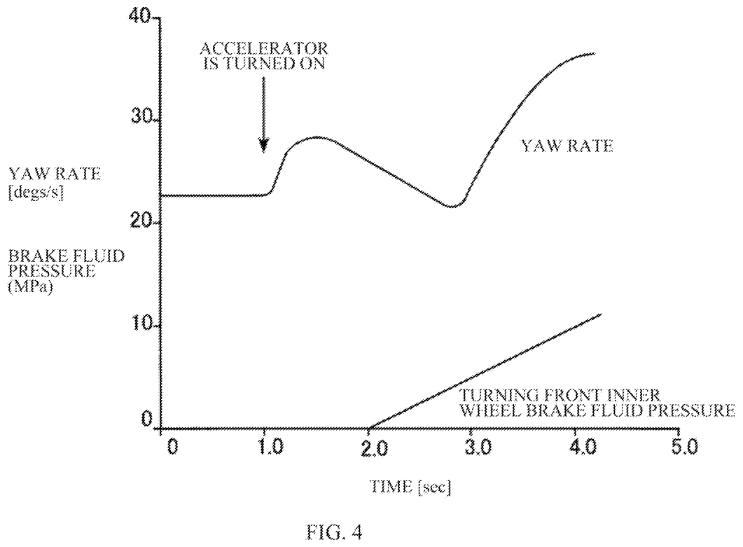

FIG. 4 is a diagram illustrating an example of transition of the yaw rate and the brake fluid pressure of the turning inner wheel when the braking force is applied to the turning inner wheel.

In FIG. 4, the vertical axis represents time (that corresponds to FIG. 3), and the vertical axis represents the yaw rate (the top represents a turning direction) and the brake fluid pressure.

As illustrated in FIG. 4, after the start of application of the braking force to the turning inner wheel, the yaw moment in the oversteer direction may be once reduced and may transition to the understeer direction, and the yaw moment in the oversteer direction may thereafter be generated again.

In contrast, the vehicle control apparatus according to the first example embodiment may incrementally correct the brake torque based on the LSD transfer torque of the drive shaft that performs the brake control on the turning inner wheel, and may thus add a desired yaw moment to the vehicle.

Note that, in the following explanation, an example where the LSD and the inner wheel braking are controlled only on the side of the front shaft is described in order to facilitate understanding. However, when the control is performed on each of a side of the front shaft and a side of the rear shaft, the target yaw moment may be divided by a predetermined control sharing ratio between the side of the front shaft and the side of the rear shaft.

A driving torque Tₒ of the turning outer wheel and a driving torque Tᵢ of the turning inner wheel may be represented by Expression 1 and Expression 2.

$${T}_{O} = \frac{{T}_{Fin}}{2} - {T}_{LSD} \qquad ( Expression 1 )$$

$${T}_{i} = \frac{{T}_{Fin}}{2} + {T}_{LSD} - {T}_{B} \qquad ( Expression 2 )$$

T_{Fin}: drive input torque to final drive (differential)
T_{LSD}: transfer torque from outer wheel to inner wheel generated by LSD operation
T_{B}: brake torque to be added to turning inner wheel

A yaw moment M_{Z} in the turning direction acting on the vehicle may be represented by Expression 3.

$${M}_{Z} = \frac{{T}_{O} - {T}_{i}}{{R}_{T}} \cdot \frac{D}{2} = \frac{- 2 \cdot {T}_{LSD} + {T}_{B}}{{R}_{T}} \cdot \frac{D}{2} \qquad ( Expression 3 )$$

R_{T}: wheel diameter
D: tread (distance between right wheel and left wheel)

Here, if T_{B}=0 is satisfied, the yaw moment M_{Z} may be a yaw moment that has been acting before the brake control override.

A yaw moment M_{Z}D in the turning direction generated by the LSD may be represented by Expression 4.

$${M}_{Z} D = \frac{- 2 \cdot {T}_{L S D}}{{R}_{T}} \cdot \frac{D}{2} = - \frac{{T}_{L S D}}{{R}_{T}} \cdot D \qquad ( Expression 4 )$$

A target yaw moment M_{Z}B (in the turning direction) generated by the brake control may be represented by Expression 5.

M_{Z}B(turning direction)=K_{Ay}·|lateral acceleration|·K_{Dt}·driving torque (Expression 5)

Here, K_{Ay} and K_{Dt} each represent a predetermined constant.

Based on this, a brake torque T_{B} for achieving the target yaw moment M_{Z}B may be represented by Expression 6.

$${T}_{B} = 2 \cdot \frac{{M}_{Z} B - {M}_{Z} D}{D} \cdot {R}_{T} = 2 ( \frac{{M}_{Z} B}{D} \cdot {R}_{T} + {T}_{LSD} ) \qquad Expression ( 6 )$$

An LSD transfer torque T_{LSD} may be represented by Expression 7.

T_{LSD}=|T_{Fin}|·TBR_{LSD}+TI_{LSD} (Expression 7)
TBR_{LSD}: input torque sensitivity coefficient of LSD transfer torque
TI_{LSD}: initial component (steady-state inner friction) of LSD transfer torque and clutch torque generated by electronic control

A target yaw rate of the vehicle may be set on an assumption of an appropriate turning state based on the steering angle of the front wheels and a vehicle speed.

For example, a target yaw rate γ may be set by Expression 8.

$$\begin{matrix}γ = ( \frac{1}{1 - \frac{m}{2 \cdot {l}^{2}} \frac{{l}_{f} \cdot {K}_{f} - {l}_{r} \cdot {K}_{r}}{{K}_{f} \cdot {K}_{r}} {V}^{2}} ) \frac{V}{l} δ \\ = \frac{1}{1 + A \cdot {V}^{2}} \frac{V}{l} δ\end{matrix} \qquad ( Expression 8 )$$

m: vehicle mass
l: wheel base
l_{f}: distance between front shaft and gravity center of vehicle
lᵣ: distance between rear shaft and gravity center of vehicle
K_{f}: equivalent cornering power of front wheel
Kᵣ: equivalent cornering power of rear wheel
V: vehicle speed
δ: front wheel steering angle
A: stability factor

The stability factor A may be represented by Expression 9.

$$A = - \frac{m}{2 \cdot {l}^{2}} \frac{{l}_{f} \cdot {K}_{f} - {l}_{r} \cdot {K}_{r}}{{K}_{f} \cdot {K}_{r}} \qquad ( Expression 9 )$$

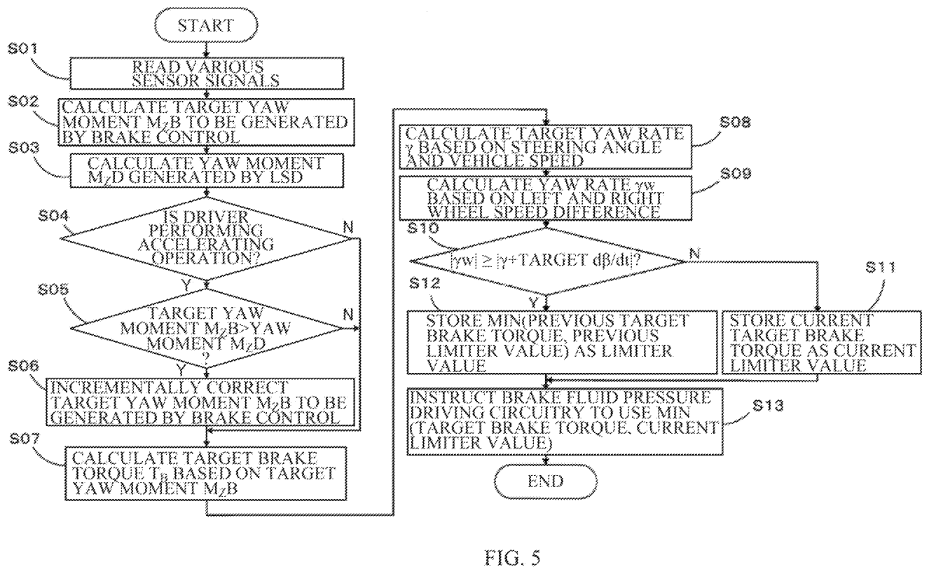

FIG. 5 is a flowchart illustrating an operation of the vehicle control apparatus according to the first example embodiment.

### <Step S01: Read Various Sensor Signals>

The brake control unit 120 may read output signals of respective sensors, and may monitor the output signals.

Thereafter, the process may proceed to step S02.

### <Step S02: Calculate Target Yaw Moment M_{Z}B to be Generated by Brake Control>

The brake control unit 120 may calculate the target yaw moment M_{Z}B to be generated by the brake control using Expression 5 described above.

Thereafter, the process may proceed to step S03.

### <Step S03: Calculate Yaw Moment M_{Z}D Generated by LSD>

The brake control unit 120 may calculate the yaw moment M_{Z}D generated by the LSD using Expression 4 described above.

Thereafter, the process may proceed to step S04.

### <Step S04: Determine Whether Driver is Performing Accelerating Operation>

The brake control unit 120 may determine whether the driver is performing an accelerating operation based on an output of the accelerator pedal sensor 72.

For example, the brake control unit 120 may determine that the user is performing the accelerating operation if an accelerator opening degree detected by the accelerator pedal sensor 72 is greater than or equal to a predetermined value.

If the brake control unit 120 determines that the driver is performing the accelerating operation (step S04: Y), the process may proceed to step S05, and if the brake control unit 120 determines that the driver is not performing the accelerating operation (step S04: N) the process may proceed to step S07.

<Step S05: Compare Target Yaw Moment M_{Z}B and Yaw Moment M_{Z}D with Each Other>

The brake control unit 120 may compare the target yaw moment M_{Z}B generated by the brake control calculated in step S02 and the yaw moment M_{Z}D generated by the LSD calculated in step S03 with each other.

If the brake control unit 120 determines that the target yaw moment M_{Z}B is greater than the yaw moment M_{Z}D (step S05: Y), the process may proceed to step S06, and if the brake control unit 120 determines that the target yaw moment M_{Z}B is not greater than the yaw moment M_{Z}D (step S05: N), the process may proceed to step S07.

### <Step S06: Incrementally Correct Target Yaw Moment M_{Z}B to be Generated by Brake Control>

The brake control unit 120 may incrementally correct, based on the yaw moment M_{Z}D generated by the LSD, the target yaw moment M_{Z}B to be generated by the brake control.

Thereafter, the process may proceed to step S07.

<Step S07: Calculate Target Brake Torque T_{B} Based on Target Yaw Moment M_{Z}B>

The brake control unit 120 may calculate the target brake torque T_{B} that is to be generated by the brake of the turning inner wheel based on the target yaw moment M_{Z}B generated by the brake control that has been incrementally corrected in step S06.

The brake control unit 120 may calculate the target brake torque T_{B} using Expression 6 described above.

Thereafter, the process may proceed to step S08.

### <Step S08: Calculate Target Yaw Rate γ Based on Steering Angle and Vehicle Speed>

The brake control unit 120 may calculate a target yaw rate γ based on a steering angle and a vehicle speed of the vehicle 1 using Expression 8 described above.

Thereafter, the process may proceed to step S09.

### <Step S09: Calculate Yaw Rate γw Based on Right and Left Wheel Speed Difference>

The brake control unit 120 may calculate a yaw rate γw based on a wheel speed difference between the right front wheel and the left front wheel detected by the vehicle speed sensor 71.

Thereafter, the process may proceed to step S10.

### <Step S10: Determine Yaw Rate γw Based on Wheel Speed Difference>

The brake control unit 120 may perform comparison between: an absolute value |γw| of the yaw rate γw based on the wheel speed difference calculated in step S09; and an absolute value |γ+target dβ/dt| of a value obtained by adding, to the target yaw rate γ calculated in step S08, a target change amount (dβ/dt) of a vehicle body slip angle β per unit time in the current traveling state of the vehicle 1.

Here, |γ+target dβ/dt| may be set based on the target yaw rate γ, and may be an allowable range of the yaw rate that is a possible value range of the vehicle 1.

If the brake control unit 120 determines that |γw|≥|γ+target dβ/dt| is satisfied (step S10: Y), the process may proceed to step S12, and if the brake control unit 120 determines that |γw|≥|γ+target dβ/dt| is not satisfied (step S10: N), the process may proceed to step S11.

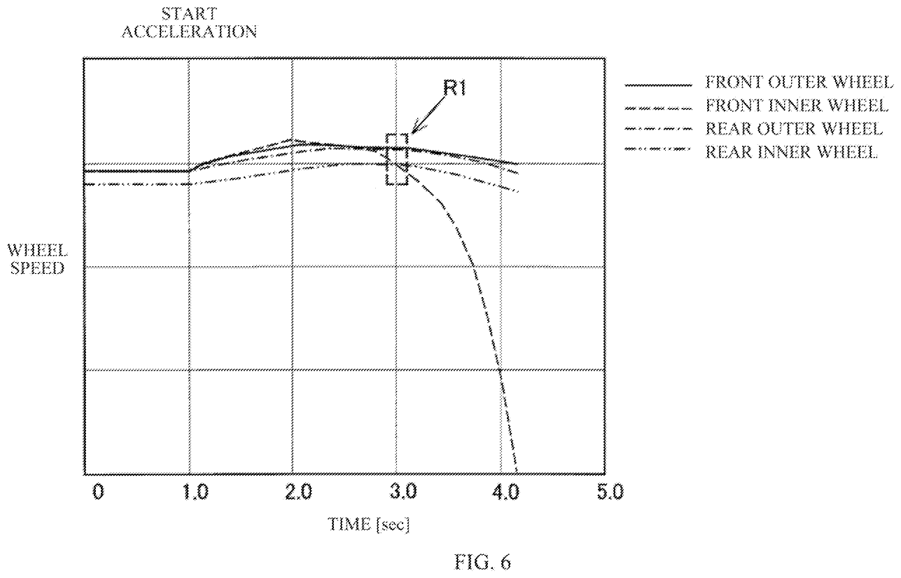

FIG. 6 is a diagram illustrating an example of transition of wheel speeds of respective wheels when braking is performed on a front wheel on a turning inner side.

In FIG. 6, the horizontal axis represents time, and the vertical axis represents the wheel speeds of the respective wheels.

In a state where the front LSD 41 is locked before the brake control override, the wheel speed of the front outer wheel and the wheel speed of the front inner wheel may substantially match with each other.

When a brake torque T_{B} is applied to the front inner wheel from this state and a driving state of the front outer wheel is cancelled, lowering in the wheel speed by the braking of the front inner wheel may start.

In contrast, when the rear LSD 51 is in the disengaged state, a wheel speed difference may occur between the rear outer wheel and the rear inner wheel corresponding to a difference in travel trajectories between the right and left wheels.

When the wheel speed difference occurs between the front outer wheel and the front inner wheel that exceeds the wheel speed difference corresponding to the difference in travel trajectories by the braking performed on the front inner wheel (i.e., the wheel speed difference in a region on the right side of a region R1 illustrated in FIG. 6), the slipping or locking of the front inner wheel may be already started. The yaw rate (the wheel speed yaw rate γw) calculated based on the wheel speed difference between the right and left wheels may not appropriately reflect a vehicle behavior.

Accordingly, in the first example embodiment, the brake torque T_{B} is set in such a manner that the revolution speed difference between the turning inner wheel and the turning outer wheel does not fall outside a predetermined range in which the yaw rate γw is detectable from the wheel speed difference by a method described below.

### <Step S11: Store Current Target Brake Torque as Current Limiter Value>

The brake control unit 120 may store a current target brake torque T_{B} as a current limiter value T_{BLim}.

The limiter value T_{BLim} is an upper limit of the brake torque.

Thereafter, the process may proceed to step S13.

### <Step S12: Store Min(Previous Target Brake Torque, Previous Limiter Value) as Limiter Value>

The brake control unit 120 may store the smaller one of a previous target brake torque T_{B} or a previous limiter value T_{BLim} as a current limiter value.

Thereafter, the process may proceed to step S13.

### <Step S13: Instruct Brake Fluid Pressure Driving Circuitry to Use Min(Target Brake Torque, Current Limiter Value)>

The brake control unit 120 may instruct the brake fluid pressure driving circuitry 121 to use the smaller one of the target brake torque T_{B} calculated based on Expression 6 or a current limiter value T_{BLim}, and cause the brake fluid pressure driving circuitry 121 to perform inner wheel braking control.

Thereafter, the brake control unit 120 may end the series of process operations.

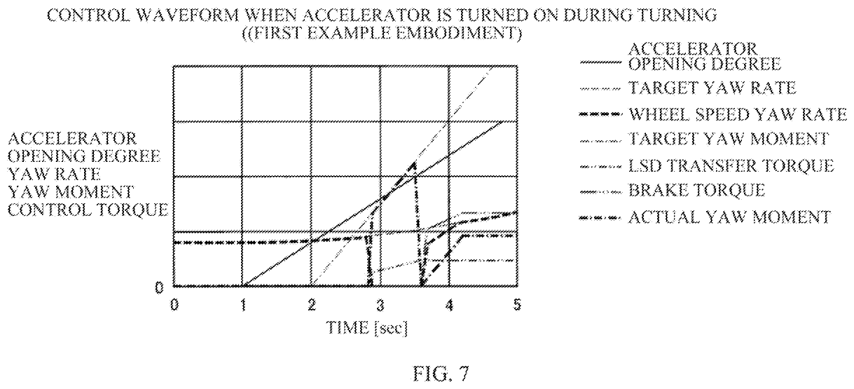

FIG. 7 is a diagram illustrating an example of a control waveform when the accelerator is turned on during turning in the vehicle control apparatus according to the first example embodiment.

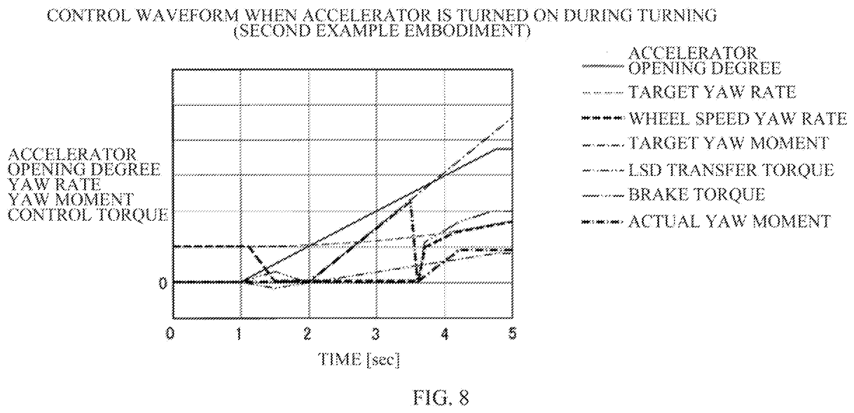

In FIG. 7, the horizontal axis represents time, and the vertical axis represents the accelerator opening degree (a solid line), the target yaw rate (a thin dashed line), the wheel speed yaw rate (a thick dashed line), the target yaw moment (a thin dashed dotted line), the LSD transfer torque (a dashed double-dotted line), the brake torque (a dashed triplicate-dotted line), and an actual yaw moment (a thick dashed dotted line). This applies similarly to FIG. 8, etc., to be described below.

In the example illustrated in FIG. 7, the accelerator may be turned on at the time point of 1 second, and the accelerator opening degree may continuously increase from this point to around 4.7 seconds.

The target yaw moment may be generated from the time point of 2 seconds, and may continuously increase as the time elapses.

In the vicinity of 2.8 seconds, the locking of the front LSD 41 may be started, and at this time, the yaw moment may be generated by the driving force of the turning outer wheel in the vehicle 1.

The yaw moment generated by the front LSD 41 may be increased along the target yaw moment up to about 3.5 seconds, following which the inner wheel braking control of applying the brake torque T_{B} may be started.

At this time, the yaw moment may be temporarily lowered due to the absorption of the LSD transfer torque T_{LSD} by the brake torque T_{B}. However, the yaw moment may be generated by the brake torque T_{B}, and the wheel speed yaw rate (the yaw rate calculated based on the wheel speed) γw may be increased to approach the target yaw rate γ.

Thereafter, in the vicinity of 4.2 seconds, the wheel speed yaw rate γw and the target yaw rate γ may be close to each other. The brake torque T_{B} at this time may be set to a limiter value B_{TLim} to thereby limit the brake torque T_{B}, and the wheel speed yaw rate γw may transition along the target yaw rate γ.

According to the first example embodiment described above, it is possible to achieve at least one of the following example effects.
(1) When the torque transmission of the front LSD 41 from the turning inner wheel to the turning outer wheel causes the yaw moment in the oversteer direction to be generated by the outer wheel driving, and the brake torque T_{B} is applied to the turning inner wheel in order to further increase the yaw moment, the brake torque T_{B} is incrementally corrected based on the transfer torque T_{LSD} of the front LSD 41. This makes it possible to, even when the transfer torque T_{LSD} of the front LSD 41 is absorbed by the brake torque T_{B}, enhance effects of the inner wheel braking and generate an appropriate yaw moment.
(2) Using the electronically controlled front LSD 41 that is able to freely set the transfer torque T_{LSD} makes it possible to prevent the yaw moment in the understeer direction from being temporarily generated by not generating the transfer torque T_{LSD} in a state where the turning inner wheel has a margin in the gripping force.

Further, after occurrence of the slipping of the turning inner wheel, the transfer torque T_{LSD} of the front LSD 41 is increased first. This makes it possible to generate the yaw moment in the oversteer direction by the outer wheel driving with high responsiveness.
(3) Limiting the wheel speed difference between the turning inner wheel and the turning outer wheel upon the inner wheel braking in such a manner as to be in a range that satisfies |γw|<|γ+target dβ/dt| makes it possible to prevent the vehicle from shifting into a spin mode due to excessive inner wheel braking, and to ensure estimation accuracy of the yaw moment γw due to the wheel speed difference between the right and left wheels.

### Second Example Embodiment

Next, the vehicle control apparatus according to a second example embodiment of the disclosure will be described.

In example embodiments to be described below, components similar to those in the previous example embodiment are denoted by the same reference numerals, and descriptions thereof will be omitted, and differences will be mainly described.

The vehicle control apparatus according to the second example embodiment may be provided in a vehicle including, as the LSD (the front LSD 41) of the drive shaft, a passive LSD of a torque-sensitive type or a differential-rotation-sensitive type in place of the electronically controlled LSD according to the first example embodiment.

Here, in the torque-sensitive LSD, the LSD transfer torque T_{LSD} may be calculated based on an input torque (a driving torque difference between the side of the turning inner wheel and the side of the turning outer wheel side).

For example, an estimate value of the LSD transfer torque T_{LSD} may be calculated by multiplying the input torque by a predetermined coefficient.

Further, in the differential-rotation-sensitive LSD such as a viscous coupling type, the LSD transfer torque T_{LSD} may be calculated based on the differential rotation (the wheel speed difference between the side of the turning inner wheel and the side of the turning outer wheel).

For example, the estimate value of the LSD transfer torque T_{LSD} may be calculated by multiplying the differential rotation by a predetermined coefficient.

FIG. 8 is a diagram illustrating an example of a control waveform when the accelerator is turned on during the turning in the vehicle control apparatus according to the second example embodiment.

The control to be performed in the second example embodiment may be basically the same as the first example embodiment. However, in the second example embodiment, the engagement force of the LSD may be generated in a region (for example, between 1 second and 2 seconds in FIG. 8) before the slipping of the turning inner wheel starts, thereby generating the LSD transfer torque T_{LSD} from the turning outer wheel to the turning inner wheel in this region and generating the yaw moment in the understeer direction (the LSD transfer torque T_{LSD} swings on the negative side).

Accordingly, in the second example embodiment, the braking force (the brake torque) may be applied to the turning inner wheel in such a region. This may cancel the yaw moment in the understeer direction generated by the LSD transfer torque T_{LSD}.

In the second example embodiment described above, effects similar to those of the first example embodiment described above are also obtainable.

### Third Example Embodiment

Next, the vehicle control apparatus according to a third example embodiment of the disclosure will be described.

According to the first example embodiment described above, incrementally correcting the brake torque T_{B} may make it possible to add the target yaw moment serving as the brake control without a dead zone. However, the third example embodiment may perform integrated control in which the yaw moment that has been acting by the LSD on the vehicle before the brake control override is added.

In view of continuity of the added yaw moment, the brake torque T_{B} that is further incrementally corrected may be represented by Expression 10.

$${T}_{B} = 2 \cdot \frac{{M}_{Z} B - 2 \cdot {M}_{Z} D}{D} \cdot {R}_{T} = 2 ( \frac{{M}_{Z} B}{D} \cdot {R}_{T} + 2 \cdot {T}_{LSD} ) \qquad ( Expression 10 )$$

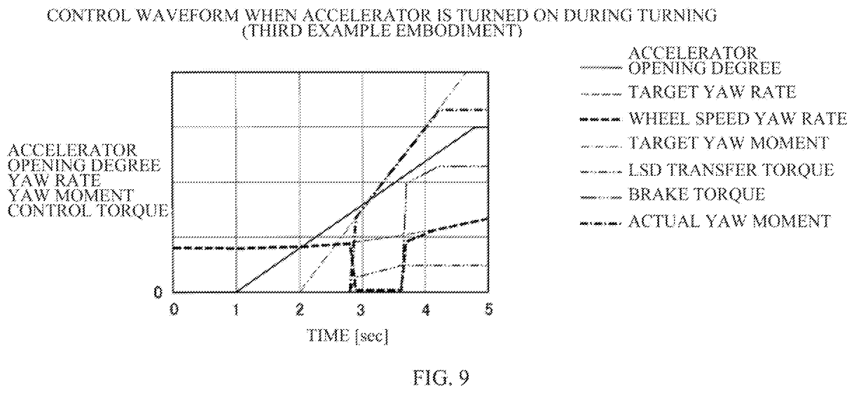

FIG. 9 is a diagram illustrating an example of a control waveform when the accelerator is turned on during the turning in the vehicle control apparatus according to the third example embodiment.

In the third example embodiment, the increment correction amount of the brake torque T_{B} may be increased as compared with the first example embodiment, which may make it possible to generate, after generation of the braking force by the braking device, the yaw moment that is higher than or equal to the yaw moment that the front LSD 41 has generated before the generation of the braking force.

As illustrated in FIG. 9, the third example embodiment may be configured in such a manner that the actual yaw moment continuously increases along the target yaw moment when brake torque is generated after the generation of the LSD transfer torque

### Fourth Example Embodiment

Next, the vehicle control apparatus according to a fourth example embodiment of the disclosure will be described.

As with the second example embodiment, the vehicle control apparatus according to the fourth example embodiment may be provided in a vehicle including, as the LSD of the drive shaft, the passive LSD of the torque-sensitive type or the differential-rotation-sensitive type in place of the electronically controlled LSD according to the first example embodiment.

Further, as with the third example embodiment, the fourth example embodiment may incrementally correct the brake torque T_{B} using Expression 9, in order to make it possible to generate, after generation of the braking force by the braking device, the yaw moment that is higher than or equal to the yaw moment that the front LSD 41 has generated before the generation of the braking force.

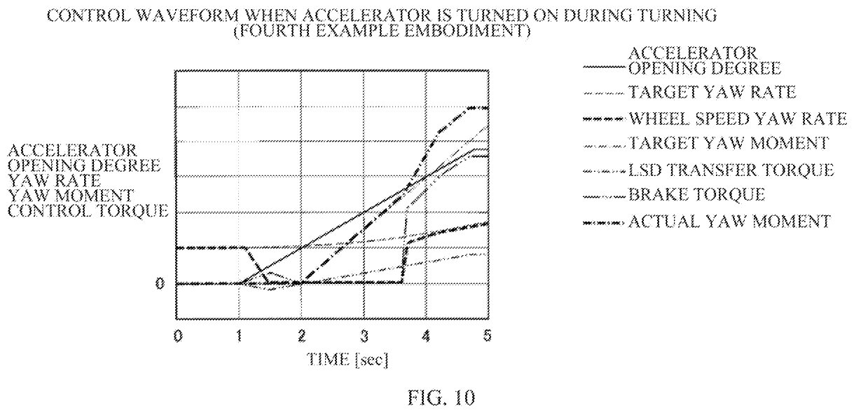

FIG. 10 is a diagram illustrating an example of a control waveform when the accelerator is turned on during the turning in the vehicle control apparatus according to the fourth example embodiment.

In the fourth example embodiment described above, effects similar to those of the third example embodiment described above are also obtainable.

### Fifth Example Embodiment

Next, the vehicle control apparatus according to a fifth example embodiment of the disclosure will be described.

The fifth example embodiment may be characterized in that the inner wheel braking control is started and the locking force of the front LSD 41 is lowered concurrently, following which the locking force is set to zero (the LSD is released).

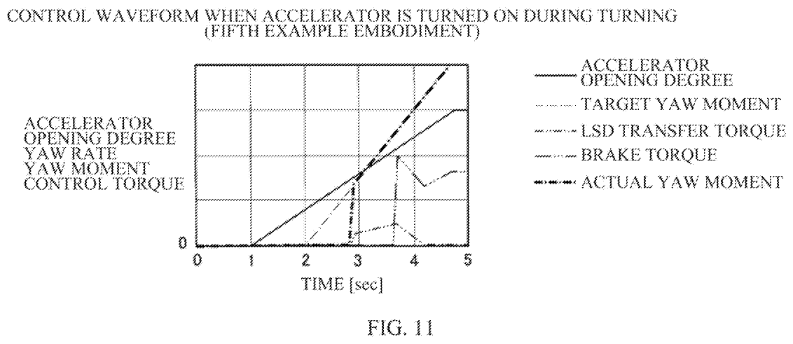

FIG. 11 is a diagram illustrating an example of a control waveform when the accelerator is turned on during the turning in the vehicle control apparatus according to the fifth example embodiment.

In the fifth example embodiment, upon override of the inner wheel braking control from the outer wheel driving state by the front LSD 41, increment correction of the brake torque T_{B} corresponding to the transfer torque T_{LSD} may be performed, and after application of the brake torque T_{B}, the transfer torque T_{LSD} of the front LSD 41 may be lowered.

As the transfer torque T_{LSD} decreases and eventually becomes zero, the increment correction of the brake torque T_{B} may also be terminated and the brake torque T_{B} may be lowered.

According to the fifth example embodiment described above, it may become possible to terminate the increment correction of the brake torque T_{B} after the front LSD 42 is released, which may make it possible to reduce friction loss caused by dragging of the brake 60.

### Modification Example

Although some example embodiments of the disclosure have been described in the foregoing by way of example with reference to the accompanying drawings, the disclosure is by no means limited to the example embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, respective configurations of the vehicle control apparatus and the vehicle are not limited to those described in the example embodiments, and are modifiable as appropriate.

For example, the vehicle described in each of the example embodiments is an all-wheel-drive vehicle in which the front shaft and the rear shaft are each the drive shaft and each include the LSD; however, the disclosure is not limited thereto. The disclosure is also applicable to an all-wheel-drive vehicle, a front-wheel-drive vehicle, or a rear-wheel-drive vehicle in which one of the front shaft or the rear shaft includes the LSD.

Further, the driving power source is not limited to the engine, and may be an electric motor or a hybrid system including the engine and the electric motor.

According to at least one example embodiment of the disclosure, it possible to provide a vehicle control apparatus that makes it possible to effectively increase a yaw moment by inner wheel braking even if the vehicle control apparatus has a limited slip differential mechanism.

With this configuration, when the torque transmission of the limited slip differential from the turning inner wheel to the turning outer wheel causes the yaw moment in the oversteer direction to be generated by the outer wheel driving, and the braking force is applied to the turning inner wheel in order to further increase the yaw moment, the braking force is incrementally corrected based on the transmission torque of the limited slip differential. This makes it possible to, even when the transmission torque of the limited slip differential is absorbed by the braking force, enhance effects of the inner wheel braking and generate an appropriate yaw moment.

In some embodiments, the target braking force setter may be configured to set the target braking force to cause a yaw moment to be generatable after generation of the braking force by the braking device, the yaw moment being higher than or equal to a yaw moment that the limited slip differential has generated before the generation of the braking force.

With this configuration, when braking of the turning inner wheel is started during generation of the yaw moment in the oversteer direction generated by the transmission torque of the limited slip differential, it is possible to prevent the yaw moment that is actually generated from being reduced temporarily, and to perform yaw moment control with high continuity.

In some embodiments, the vehicle control apparatus may further include a limited slip differential processor configured to control the transmission torque of the limited slip differential. The limited slip differential processor may be configured to increase the transmission torque based on an increase in slipping of the turning inner wheel caused by an increase in a driving force of the turning inner wheel.

With this configuration, using the limited slip differential of, for example, the electronically controlled type, makes it possible to prevent the yaw moment in the understeer direction from being temporarily generated by not generating the transmission torque in a state where the turning inner wheel has a margin in the gripping force.

Further, after occurrence of the slipping of the turning inner wheel, the transmission torque of the limited slip differential is increased first. This makes it possible to generate the yaw moment in the oversteer direction by the outer wheel driving with high responsiveness.

In some embodiments, the vehicle control apparatus may further include a limited slip differential processor configured to control the transmission torque of the limited slip differential. The limited slip differential processor may be configured to cause the braking device to add a braking force to the turning inner wheel and lower the transmission torque.

With this configuration, the transmission torque of the limited slip differential is lowered while adding the braking force to the turning inner wheel. This makes it possible to reduce loss caused by dragging of the brake upon the absorption of the transmission torque of the limited slip differential by the inner wheel braking.

In some embodiments, the vehicle control apparatus may further include a revolution speed difference detector configured to detect a revolution speed difference between the turning inner wheel and the turning outer wheel. The target braking force setter may be configured to set the target braking force to cause the revolution speed difference not to fall outside a predetermined range.

With this configuration, the target braking force is set in such a manner that the revolution speed difference does not fall outside the predetermined range. This makes it possible to prevent the vehicle from shifting into a spin mode due to excessive inner wheel braking, and to ensure estimation accuracy of the yaw rate due to the wheel speed difference between the right and left wheels.

In some embodiments, the vehicle control apparatus may further include: a target yaw rate setter configured to set a target yaw rate of the vehicle; and a yaw rate estimator configured to estimate an estimated yaw rate based on the revolution speed difference. The predetermined range may be set to cause the estimated yaw rate not to fall outside an allowable range, the allowable range being set based on the target yaw rate.

With this configuration, the effects described above are easily obtainable with a simple logic.

The brake control unit 120 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the brake control unit 120 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the brake control unit 120 illustrated in FIG. 1.

1. A vehicle control apparatus to be applied to a vehicle, the vehicle comprising a turning inner wheel, a turning outer wheel, and a limited slip differential, the limited slip differential being configured to transmit a torque between the turning inner wheel and the turning outer wheel, and configured to limit differential rotation between the turning inner wheel and the turning outer wheel, the vehicle control apparatus comprising:
a target yaw moment setter configured to set a target yaw moment of the vehicle;
a target braking force setter configured to set a target braking force to be added to the turning inner wheel based on the target yaw moment; and
a braking device configured to add a braking force to the turning inner wheel based on the target braking force, wherein
the target braking force setter is configured to incrementally correct the target braking force based on a transmission torque transmitted from the turning inner wheel to the turning outer wheel by the limited slip differential.

2. The vehicle control apparatus according to claim 1, wherein the target braking force setter is configured to set the target braking force to cause a yaw moment to be generatable after generation of the braking force by the braking device, the yaw moment being higher than or equal to a yaw moment that the limited slip differential has generated before the generation of the braking force.

3. The vehicle control apparatus according to claim 1, further comprising
a limited slip differential processor configured to control the transmission torque of the limited slip differential, wherein
the limited slip differential processor is configured to increase the transmission torque based on an increase in slipping of the turning inner wheel caused by an increase in a driving force of the turning inner wheel.

4. The vehicle control apparatus according to claim 2, further comprising
a limited slip differential processor configured to control the transmission torque of the limited slip differential, wherein
the limited slip differential processor is configured to increase the transmission torque based on an increase in slipping of the turning inner wheel caused by an increase in a driving force of the turning inner wheel.

5. The vehicle control apparatus according to claim 1, further comprising
a limited slip differential processor configured to control the transmission torque of the limited slip differential, wherein
the limited slip differential processor is configured to cause the braking device to add a braking force to the turning inner wheel and lower the transmission torque.

6. The vehicle control apparatus according to claim 2, further comprising
a limited slip differential processor configured to control the transmission torque of the limited slip differential, wherein
the limited slip differential processor is configured to cause the braking device to add a braking force to the turning inner wheel and lower the transmission torque.

7. The vehicle control apparatus according to claim 1, further comprising
a revolution speed difference detector configured to detect a revolution speed difference between the turning inner wheel and the turning outer wheel, wherein
the target braking force setter is configured to set the target braking force to cause the revolution speed difference not to fall outside a predetermined range.

8. The vehicle control apparatus according to claim 2, further comprising
a revolution speed difference detector configured to detect a revolution speed difference between the turning inner wheel and the turning outer wheel, wherein
the target braking force setter is configured to set the target braking force to cause the revolution speed difference not to fall outside a predetermined range.

9. The vehicle control apparatus according to claim 7, further comprising:
a target yaw rate setter configured to set a target yaw rate of the vehicle; and
a yaw rate estimator configured to estimate an estimated yaw rate based on the revolution speed difference, wherein
the predetermined range is set to cause the estimated yaw rate not to fall outside an allowable range, the allowable range being set based on the target yaw rate.

10. The vehicle control apparatus according to claim 8, further comprising:
a target yaw rate setter configured to set a target yaw rate of the vehicle; and
a yaw rate estimator configured to estimate an estimated yaw rate based on the revolution speed difference, wherein
the predetermined range is set to cause the estimated yaw rate not to fall outside an allowable range, the allowable range being set based on the target yaw rate.

11. A vehicle control apparatus to be applied to a vehicle, the vehicle comprising a turning inner wheel, a turning outer wheel, and a limited slip differential, the limited slip differential being configured to transmit a torque between the turning inner wheel and the turning outer wheel, and configured to limit differential rotation between the turning inner wheel and the turning outer wheel, the vehicle control apparatus comprising:
circuitry configured to
set a target yaw moment of the vehicle,
set a target braking force to be added to the turning inner wheel based on the target yaw moment, and
incrementally correct the target braking force based on a transmission torque transmitted from the turning inner wheel to the turning outer wheel by the limited slip differential; and
a braking device configured to add a braking force to the turning inner wheel based on the target braking force.
